(19) United States
(12) Patent Application Publication
(10) Pub. No.: US 2011/0138469 A1
(43) Pub. Date: Jun. 9, 2011

(54) SYSTEM AND METHOD FOR RESOLVING VULNERABILITIES IN A COMPUTER NETWORK

(75) Inventors: Qin Ye, Plano, TX (US); Deren G. Ebdon, Carrollton, TX (US); John Patoskie, Allen, TX (US)

(73) Assignee: RECURSION SOFTWARE, INC., Frisco, TX (US)

(21) Appl. No.: 12/629,933

(22) Filed: Dec. 3, 2009

(51) Int. Cl. G06F 11/00; G06F 15/173

(52) U.S. Cl. 726/25; 717/173; 709/224

(57) ABSTRACT

In a computer network, a remedy server may be provided that controls vulnerability scans of the computer nodes. The remedy server determines a security level of a computer node and dispatches an agent to the node with a scan matching the security level. The agent executes the scan and reports the scan results to the remedy server. The remedy server collates scan results from a plurality of the network computers and determines which computers have a common vulnerability. A fix for the vulnerability, such as an executable patch file, is retrieved and multicast to those relevant computers.

### FIELD OF THE INVENTION

This disclosure relates to systems and methods for providing patches on computer networks and in particular to determining and fixing vulnerabilities on one or more nodes of a computer network.

### BACKGROUND OF THE INVENTION

Nowadays, computers are no longer luxury items. They have become a necessity in almost all work environments including banks, companies, governments etc for accounting, software development, inventory, general word processing and the like. On one hand, productivity has increased dramatically bringing quality of life improvements and large increases in communications, flexibility and freedoms. On the other hand, computer crimes such as illegal access, illegal interception and data interference pose a big threat. Security risk management is emerging as one of the top concerns. People want their computers free of virus and spyware. Detecting vulnerability of a computer, downloading a fix and applying a patch has become a routine job for a lot of administrators and individuals who maintain and use computers.

An administrator is usually responsible for maintaining the sanity check on all the computers in the local network. Their job includes routinely running virus scans, finding an appropriate patch, downloading the patch and applying the patch on all the vulnerable or infected nodes.

The problem with this process is that it is highly manual. A lot of times an administrator needs to manually pull a fix and apply the fix on a node even when auto update features of the operating software are enabled. In addition, high manual intervention is required for nodes that have high security needs.

What is required is an improved system and method for detecting vulnerability of a network node and for fixing or isolating the vulnerable node.

### SUMMARY OF THE INVENTION

In one aspect of the disclosure, there is provided a method for resolving vulnerabilities on a computer network comprising a plurality of nodes. The method comprises collating vulnerability results from a plurality of the nodes, determining a plurality of nodes with a common vulnerability, retrieving an executable fix for the common vulnerability, and multicasting the executable fix to a plurality of the nodes with the common vulnerability.

In one aspect of the disclosure, there is provided a computer network comprising a plurality of computer nodes and a remedy server. The remedy server may be configured to determine a scan for a computer node, provide the scan to the computer node and receive a scan result from the computer node that indicates vulnerabilities exhibited by the respective computer node. From the scan results of a plurality of the computers, the remedy server may determine one or more vulnerabilities of the plurality of the computer nodes. The remedy server retrieves one or more fixes for the one or more vulnerabilities of the plurality of computer nodes and provides the one or more fixes to the plurality of computer nodes.

In one aspect of the disclosure, there is provided a computer-readable medium comprising computer-executable instructions for execution by at least one processor, that, when executed, cause the at least one processor to receive a plurality of scan results that indicate one or more vulnerabilities on a plurality of computers of a computer network, generate a vulnerability table that associates a vulnerability with one or more of the plurality of computers that exhibit the vulnerability, and store the vulnerability table in a memory.

### BRIEF DESCRIPTION OF THE DRAWINGS

Reference will now be made, by way of example only, to specific embodiments and to the accompanying drawings in which:

FIG. 1 illustrates a computer network with a remedy server;

FIG. 2 illustrates a method for resolving vulnerabilities on the computer network;

FIG. 3 illustrates a remedy server in communication with nodes of the network;

FIG. 4 illustrates a configuration table;

FIG. 5 illustrates a vulnerability table;

FIG. 6 illustrates a treatment table;

FIG. 7 illustrates an embodiment of the remedy server;

FIG. 8 illustrates a process for performing vulnerability testing on computers with different security levels;

FIG. 9 illustrates a process for building a vulnerability table;

FIG. 10 illustrates a process for providing a fix to a vulnerability detected on the network;

FIG. 11 illustrates a processor and memory of the remedy server;

FIG. 12 illustrates an instruction set executable on the processor of FIG. 11; and

FIG. 13 illustrates the processor of the remedy server in communication with a processor of a network computer.

### DETAILED DESCRIPTION OF THE INVENTION

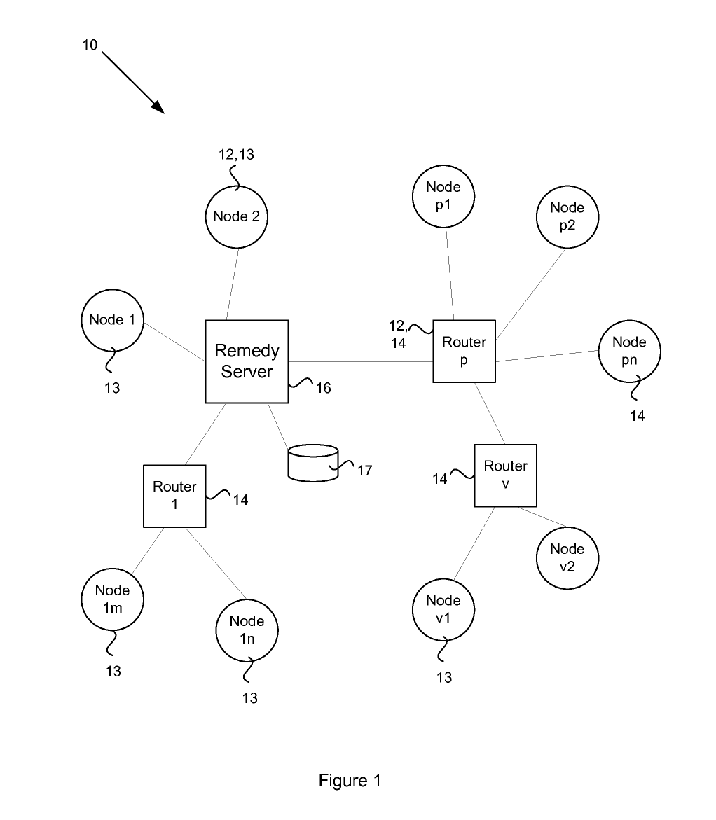

In FIG. 1, there is shown a network 10 providing a distributed agent-based security environment. The network 10 is composed of networked computer nodes 12 including computer workstations 13 and routers 14 and other relevant network components. The network 10 may be based on any suitable network architecture and may include fixed workstations, laptops, hand held devices, etc. The network communications may include fixed line, optical, wireless or any appropriate communications technology.

The network 10 includes a remedy server 16. There exists a configurable rule set, which may be stored in a database 17 that is operatively associated with the remedy server and can be looked up by the remedy server 16. The rules specify which set of nodes 12 in the local network have high security restrictions. As a result these high security nodes need a more advanced vulnerability scan mechanism and short scan interval to meet the high security requirement. The rest of the nodes in the network 10 can make use of a less expensive vulnerability scan mechanism.

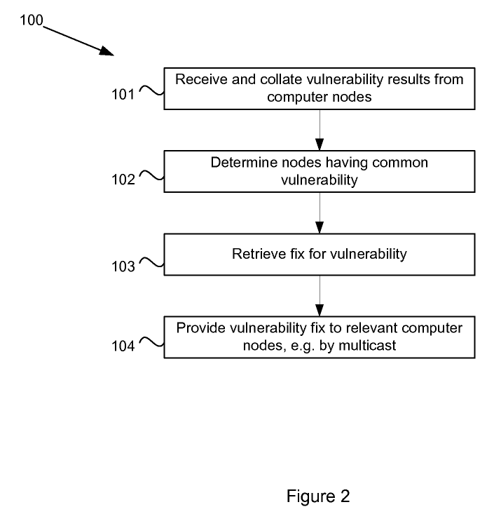

FIG. 2 shows a method 100 for resolving vulnerabilities on the network 10. At step 101 the remedy server 16 receives and collates vulnerability results, e.g. scan results, from a plurality of the nodes. The collated results are then used to determine which nodes have a common vulnerability (step 102). An executable fix is retrieved for the common vulnerability (step 103) and provided to those computer nodes which exhibit the vulnerability, e.g. by multicasting the fix.

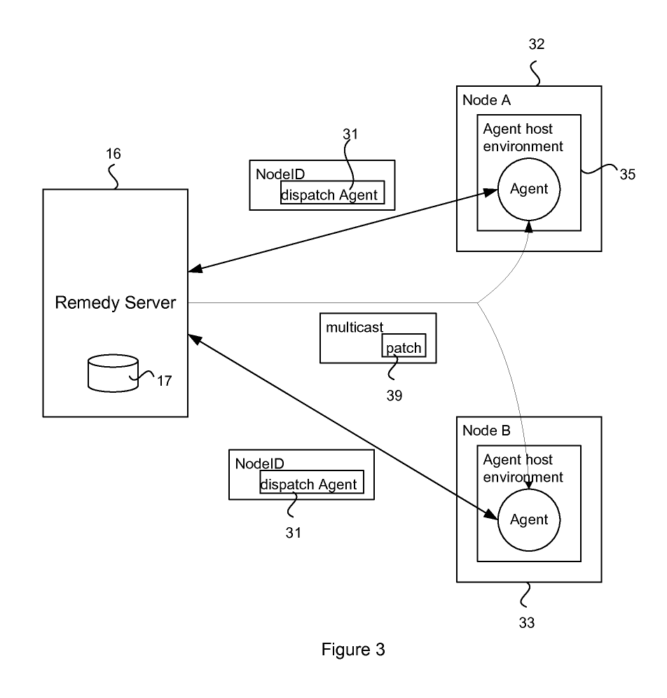

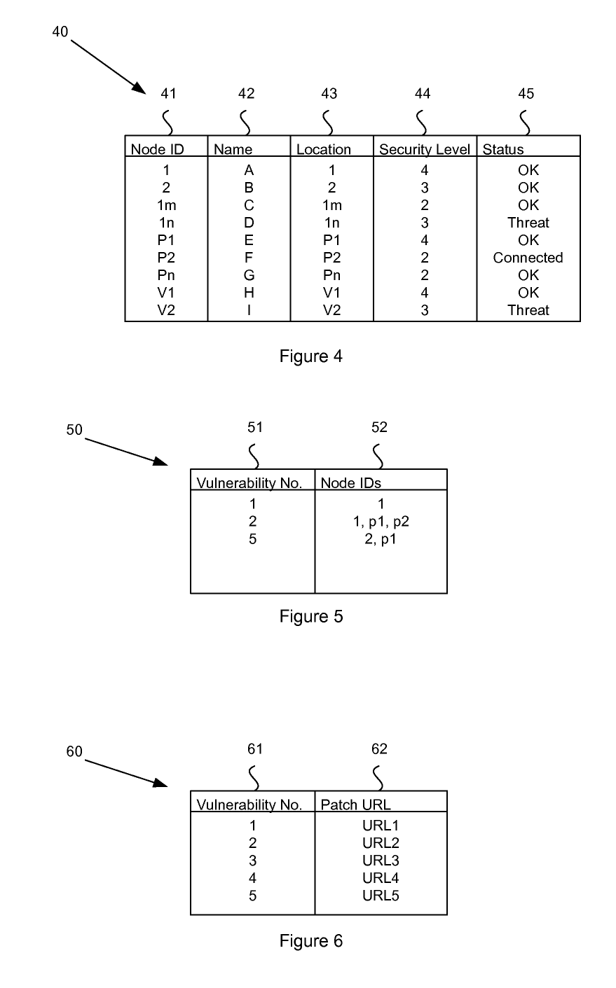

As shown in more detail in FIG. 3, the remedy server 16 looks up the rules in database 17 and dispatches agents 31 to the nodes 12 in the local network 10. Each agent 31 arrives at a designated node, e.g. Node A 32, Node B 33, etc. and performs a vulnerability scan on the respective node. The nodes are configured with an agent host environment 35 that is configured to listen for, receive and run the agents from the remedy server 16. The agent 31 carries the scan result back to the remedy server 16. Based on the result sent back by the agent, the remedy server 16 updates a configuration table and collates the vulnerability results into a vulnerability table. An example configuration table 40 (or equivalent data structure) is shown in FIG. 4, which identifies the node id 41, node name 42, location of a node 43, security level of the node 44 and the current status of the node 45. An example vulnerability table 50 (or equivalent data structure) is shown in FIG. 5, which maps a vulnerability number 51, or similar identifier, with the node identities 52 which have reported that vulnerability. Based on the vulnerability table 50, the remedy server 16 can multicast patches 39 to those nodes that have reported a particular vulnerability. Vulnerabilities that may be reported in a vulnerability scan may include, without limitation, viruses, malware, spyware, adware, Trojan Horses, worms, blended threats (combinations of viruses, worms, and Trojans Horses), weak passwords, unencrypted files of a sensitive nature, password files, lack of a software firewall, permissive settings for a firewall, versions of software applications and drivers that are known to have vulnerabilities or a new version available, and weak permissions set on critical directories or files.

The remedy server 16 also maintains a treatment table 60 (or equivalent data structure) as shown in FIG. 6 which maps different possible or known vulnerabilities 61 with a location of the actual fix 62, such as a URL of a downloadable patch, which can be used to resolve the vulnerability. A benefit of the approach is it is relatively easy for an administrator to keep the mapping table up to date whenever a new fix is available. It also avoids the need for redundant patch downloading.

By looking at the vulnerability table 60 the remedy server 16 can multicast fixes to all infected nodes that have the same vulnerability. The remedy server 16 thus controls what kind of vulnerability scan scheme should be used on a node, how frequently the scan should be run and what patch should be applied to fix the security hole. The remedy server 16 schedules the scan based on overall system state and system requirements to achieve the goals of a secure network with the least cost and interruption.

An agent that is sent to a node can be moved to a different node to perform tasks that are required by that node. The remedy server 16 has the option to dispatch several agents to a node or move an agent between the nodes. Each agent carries on a different task on the node. It facilitates the curing process for an ailing node.

When an agent arrives at a designated node, depending on the tasks assigned by the remedy server, it can run the vulnerability scan, apply a patch, update software or prepare the scan report needed by the server. In some cases, the remedy server 16 (FIG. 3) lets an agent 31 carry an executable to a node 32, 33. The agent 31 executes the executable at the node and brings the executable back to the server. By comparing the original executable with the one that was sent back, the server can detect a virus on the node. Based on the severity of the problem, the remedy server has the options of sending a shutdown to the infected node or disconnecting the node from the local network to minimize the virus exposure to the rest of the nodes. This means that the fix will require human intervention. In one embodiment, the remedy server can prepare a fix for an administrator to apply manually and notify the administrator via email/pager/etc.

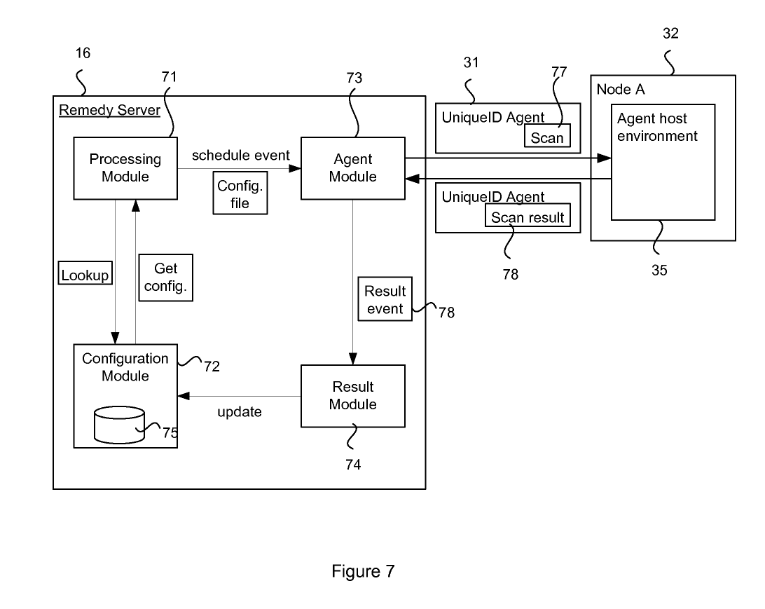

An embodiment of the remedy server 16 is illustrated in FIG. 7. The remedy server 16 of FIG. 7 includes a processing module 71, a configuration module 72, an agent module 73 and a result module 74. A rule engine 75 executes inside the configuration module 72. The rule engine 75 has a set of configurable rules and takes an input, which includes topology of the network, node id, node name, location of the node, security level of the node and status of the node and produces a configure file.

The Processing Module 71 retrieves relevant information from the Configuration Module 72. Based on the security level of a node to be analyzed, e.g. Node A 32, the processing module 71 fetches an appropriate scanner 77 for the node. For example, a node with a high security level receives a comprehensive detail oriented scanner. The Processing Module 71 is responsible for dispatching an agent 31 from the agent module 73 to the node 32 to perform the vulnerability scan 77. Each node in the network has a unique identifier and each agent has a unique identifier as well. The agent 31 executes within the agent host environment 35 on the Node 32 to perform the relevant scan and returns scan results 78 to the Result Module 74 via the processing module 71 and/or the agent module 73. If the scan results indicate no vulnerability on the node, the agent sends an “OK” status back. Otherwise it marks down the vulnerability numbers for the node. If the vulnerability result sent back to the server indicates a serious virus on a node that might cause harm to the local network, the remedy server can temporarily disconnect the infected node from the local network. For example, if an executable carried back from a node by an agent has been altered in any way, the status of the node is marked as “Threat”. In that case the remedy server has the option to temporarily disconnect the node from the local network to minimize the potential damages to the local network. Once the problem has been resolved, the status of the node will be marked as “OK”, and the remedy server can put that node back to the network.

The Result Module 74 is responsible for collating the scan results and building the vulnerability table 50 shown in FIG. 5, which maps a vulnerability number 51 with the node ids 52 of nodes which have reported that vulnerability. Using the vulnerability table 50, the remedy server, e.g. the Processing Module 71, identifies all nodes with a common vulnerability number and sends out agents to the target machines with common vulnerabilities. The remedy server then looks up the Treatment Table 60 to find out the fix for the vulnerability, retrieves the fixes and multicasts the fixes, e.g. executable patch files, to the target machines. The agents on the infected nodes listen for the multicast patch event, receive the patch and execute the patch file to resolve the infection. The Result Module 74 is also responsible for updating the status of the node in the Configuration Module 62 once a vulnerability has been resolved.

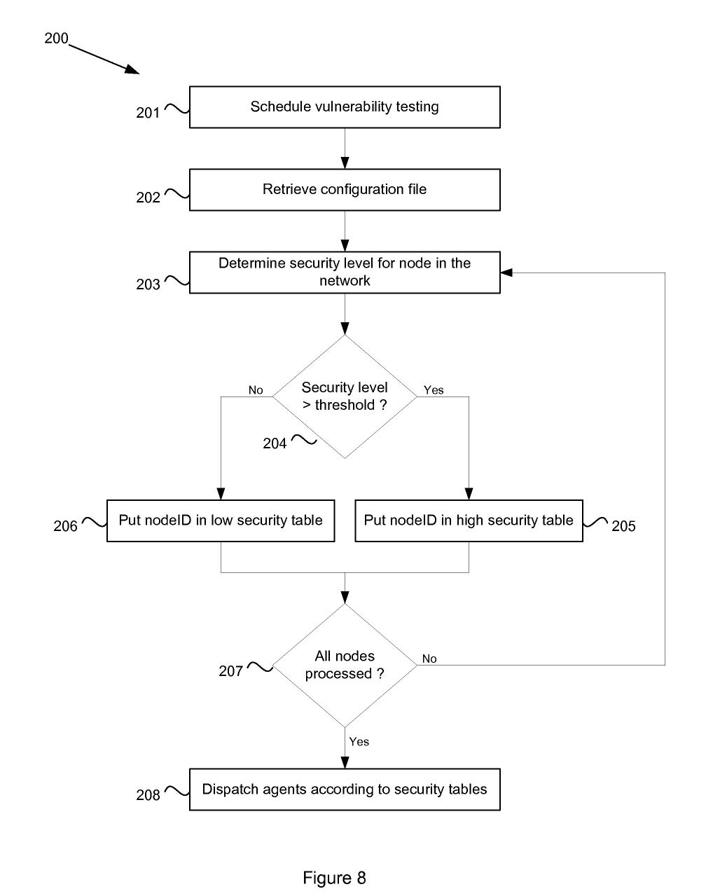

Further operation of the processing module 71 is described with reference to the flowchart 200 of FIG. 8. A scheduled vulnerability test is triggered at step 201 causing the processing module 71 to retrieve the configuration file from the configuration module 72 (step 202). The security level of a first node in the network is determined from the configuration file (step 203). If the security level is above a threshold (decision step 204) then the node is placed in a high security table (step 205), otherwise, the node is placed in a low security table (step 206). If there are further nodes to be processed (decision step 207), then the next node is selected from the configuration file and the process 200 returns to step 203. Agents with scanners may then be dispatched to the nodes (step 208) depending on the node's security level. While two separate security levels are indicated in this example, in practice, any number of differing security levels may be used.

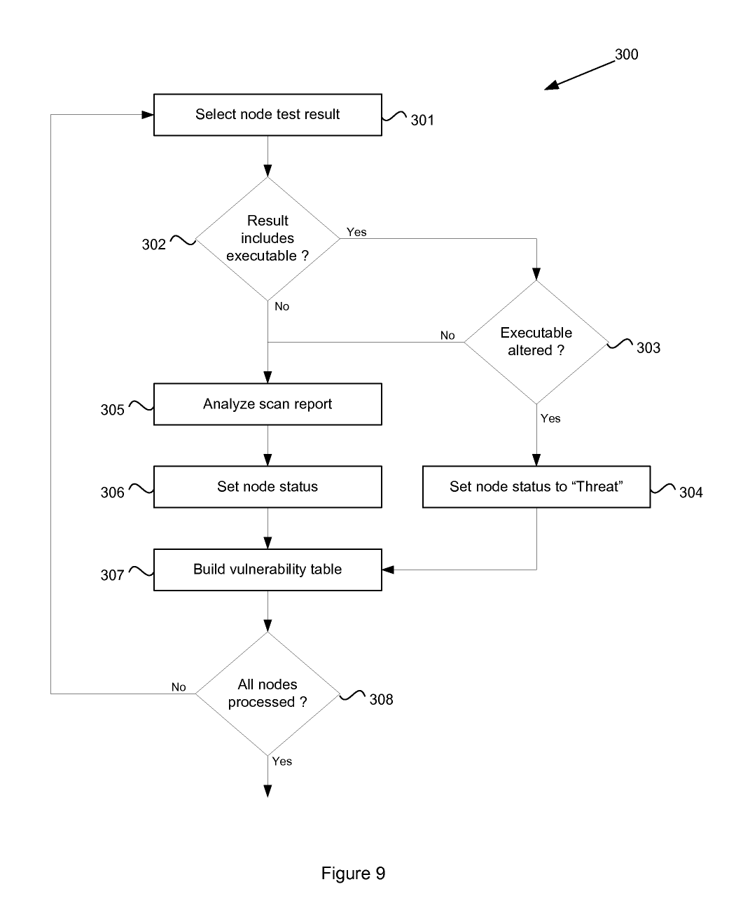

Collating and processing of agent scan results by the Result Module 74 will now be described with reference to the flowchart 300 of FIG. 9. At step 301, a first node test result is selected, e.g. as the result is received from the agent at the respective node. If the result includes an executable file (decision step 302), then the executable is analyzed to determine if the executable was altered by the node (step 303). If so, then the Result Module 74 updates the node status 45 in the configuration table 40 to “Threat” or some similar indicator that a virus may be present on the node (step 304). The process then proceeds to build the vulnerability table 50 (step 307) by adding the node ID to the vulnerability number of the indicated virus. If the agent results do not return an executable or if the executable returned by the agent is unaltered, then the scan report is analyzed 305 and the node status 45 is set depending on whether the scan results indicate “OK” or some other vulnerability indicator (step 306). The result module 64 then builds the vulnerability table 50 (step 307) by adding the node ID of the node to any vulnerability numbers indicated in the agent scan report. If further node results are to be processed (decision step 308), then the process returns to step 301 for a next node.

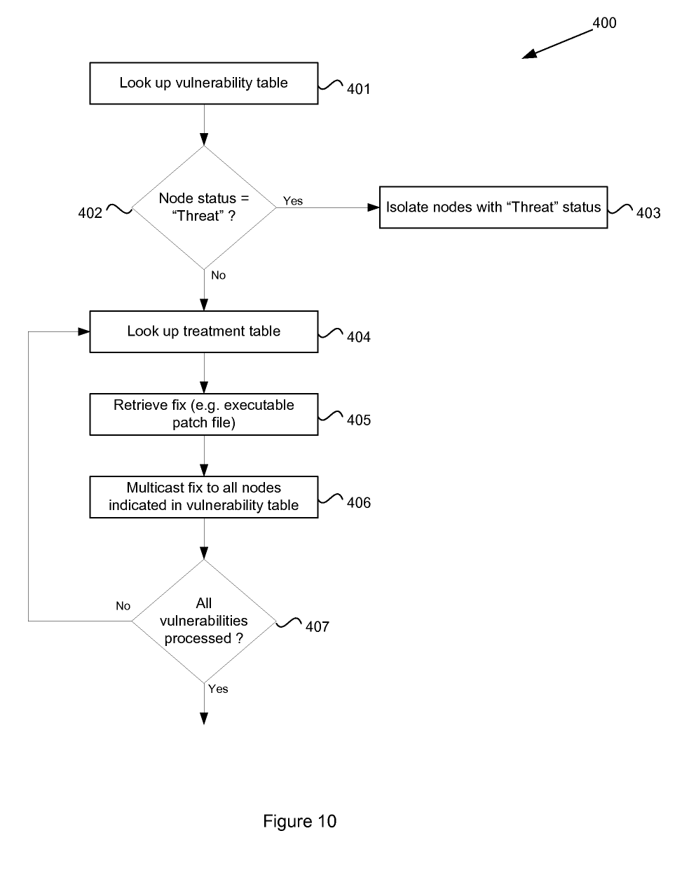

A process of the processing module 71 for handling the vulnerabilities is shown in the flowchart 400 of FIG. 10. At step 401, the processing module 71 looks up the vulnerability table 50 to determine what vulnerabilities have been reported. If at decision 402 the processing module determines that the status of any of the nodes are set to “Threat”, then the processing module takes measures to temporarily isolate those nodes from the network (step 403). Then, starting with a first vulnerability 51 reported in the vulnerability table 50, the processing module 71 accesses the treatment table 60 (step 404), pulls the fix (step 405) from the indicated location 62, e.g. an executable patch file, and multicasts the fix (step 406) to all nodes 52 that are indicated in the vulnerability table 50 to exhibit that vulnerability. If further vulnerabilities are to be processed (decision step 407), the next vulnerability of the vulnerability table 50 is selected and the process returns to step 404 until all vulnerabilities of the vulnerability table 50 have been appropriately handled.

While the nodes have been referred to herein as being of high or low security levels with agents being dispatched with high security scanners or low security scanners dependent on a node's security level, a person skilled in the art will recognize that multiple security levels may be used and/or there may be no distinction between security levels applied across the network.

Using the embodiments described above, an administrator only needs to work with the remedy server, which is the centerpiece of the security control for the network. With the approaches described above, the administrator of the computer network has total control of what kind of fixes need to applied, when they need to be applied and where they should be applied. If anything changes the administrator just needs to make changes to the rules to accommodate any new requirements, such as a more sophisticated scanner, higher scan frequency for higher secured site nodes etc. The provision of a fix using multicast provides an efficient way of implement the fix network wide. It also provides optimized network performance, resource reduction, scalability and reduced network load. The remedy server is responsible for scheduling the vulnerability test, getting reports back from all the nodes in the network and sending out appropriate patches where required. It is much more efficient than the administrator working with each individual machine and dealing with problems one at a time. A further advantage is that using the rules engine 75 of the configuration module 72, the system can be configured to adapt different security models within the local network. The remedy server can adjust the vulnerability scan interval based on the rules, the feedback from each individual node, and the state of the system. When a patch is available, the efficiency across a network can be maximized by multicasting the patches to all the vulnerable and infected nodes within the network.

The embodiments described above are therefore capable of increasing efficiency by reducing redundant work. The system enables intelligent reasoning for the remedy process.

Advantages of the described system include the prevention of potential computer crimes for companies or government that have multiple computers connected through a local network. The system also adapts the needs that some of the nodes in the network have higher security restriction than the rest of the nodes. It has a systematic approach to make sure nodes in the network are operating with a high security standard with minimum cost.

The solutions enable organizations to ensure the confidentiality of information, reduce the time and costs associated with an inefficient remedy process, and facilitate compliance with organizational security policies and government mandates.

The most commonly used approach for the existing System is using a daemon process, which consumes memory and processor resources in the host environment continuously. Unlike prior art systems, that utilize a daemon process running in the test machine, the system of the present disclosure sends agents to perform different tasks only if it is scheduled by the remedy server. When the job is done, the agents will leave the target machine.

The system has particular advantage for vulnerability checks, upgrades and fixes for a large number of nodes that are inter-connected through a local network. It especially works well with heterogeneous nodes that have different levels of security.

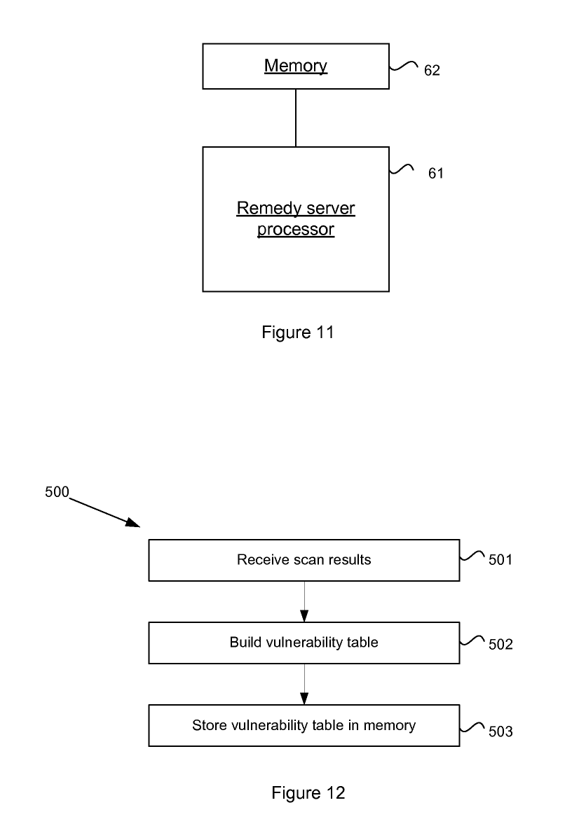

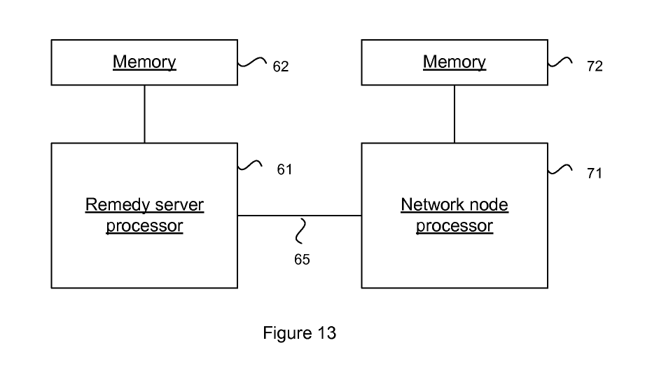

The components of the network 10 may be embodied in hardware, software, firmware or a combination of hardware, software and/or firmware. In a hardware embodiment shown in FIG. 11, the remedy server 16 may include one or more processors (shown as a single processor in FIG. 11) that is operatively associated with a memory 62. The memory 62 may store an instruction set executable by the processor 61. When executed, the instruction set 500, shown in FIG. 12, allows the processor 61 to receive a plurality of scan results from the network computers. The processor then generates a vulnerability table or some similar data structure that associates a vulnerability with one or more of the plurality of computers that exhibit the vulnerability (step 502). The vulnerability table may be stored in a database or memory, such as memory 62, and looked up when providing a fix for a vulnerability to computers on the network. As shown in FIG. 13, the processor 61 may communicate via a link 65 with other processors 71, such as a processor of a computer node 13 on the network 10 which may also be operatively associated with its own memory 72. Through the link 65, the processor 61 may receive scan results from the network computers and also dispatch agents to the network computers for generating the scan results, executing patch files, performing software updates and the like.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A method for resolving vulnerabilities on a computer network comprising a plurality of nodes, the method comprising:
collating vulnerability results from a plurality of the nodes;
determining a plurality of nodes with a common vulnerability;
retrieving an executable fix for the common vulnerability; and
multicasting the executable fix to a plurality of the nodes with the common vulnerability.

2. The method according to claim 1 comprising providing an agent to a plurality of nodes with the common vulnerability, the agent being configured to:
execute within a node;
receive the executable fix into the node; and
execute the executable fix on the node.

3. The method according to claim 1 wherein collating vulnerability results comprises building a vulnerability table that maps a vulnerability to one or more nodes that indicate the vulnerability in vulnerability results for the respective node.

4. The method according to claim 1 comprising providing an agent to the plurality of nodes, the agent being configured to generate the vulnerability results.

5. The method according to claim 4 wherein the agent is configured to:
convey an executable file to a node;
execute the executable file on the node; and
return the executable file after execution on the node;
wherein the method comprises:
analyzing an executable file after execution on a node to determine if the executable file has been modified by execution on the node; and
isolating from the network a node which has modified an executable file.

6. The method according to claim 4 wherein the agent is configured to execute a vulnerability scan on a node.

7. The method according to claim 6 comprising:
selecting a vulnerability scan for a node; and
providing the vulnerability scan with the agent to the node.

8. The method according to claim 7 comprising:
determining a security level of a node; and
selecting a vulnerability scan for the node dependent on the security level.

9. The method according to claim 1 comprising maintaining a fix table that maps a vulnerability to a location of a fix for the vulnerability, wherein retrieving a fix for a vulnerability comprises looking up a vulnerability in the fix table.

10. A computer network comprising:
a plurality of computer nodes; and
a remedy server configured to:
determine a scan for a computer node;
provide the scan to the computer node;
receive a scan result from the computer node that indicates vulnerabilities exhibited by the respective computer node;
determine one or more vulnerabilities of the plurality of the computer nodes from a plurality of scan results;
retrieve one or more fixes for the one or more vulnerabilities of the plurality of computer nodes; and
provide the one or more fixes to the plurality of computer nodes.

11. The computer network according to claim 10 wherein the remedy server comprises an agent module configured to provide at least one agent to at least one computer node and wherein the at least one computer node supports an agent host environment that is configured to receive and execute the at least one agent.

12. The computer network according to claim 11 wherein the at least one agent comprises an agent configured to provide a scan to a computer node and to execute the scan.

13. The computer network according to claim 12 wherein the remedy server comprises a configuration module that stores a security level of a plurality of the computer nodes; wherein the remedy server is configured to select a scan to provide to a computer node depending on the security level of the computer node.

14. The computer network according to claim 11 wherein the at least one agent comprises an agent configured to:
convey an executable file to a computer node;
execute the executable file; and
return the executable file to the remedy server;
wherein the remedy server is configured to:
analyze a returned executable file to determine if the returned executable file has been modified during execution at the computer node; and
isolate the computer node from the network if the returned executable file has been modified by the computer node.

15. The computer network according to claim 10 wherein the remedy server comprises a result module that is configured to receive the plurality of scan results and generate a vulnerability table that associates a vulnerability with one or more of the plurality of computer nodes that exhibit the vulnerability.

16. The computer system according to claim 15 wherein the remedy server is configured to:
look up the vulnerability table to determine a plurality of computer nodes with a common vulnerability;
retrieve a fix for the common vulnerability; and
multicast the fix to the plurality of computer nodes with the common vulnerability.

17. The computer system according to claim 16 wherein a plurality of the computer nodes support an agent host environment that is configured to receive and execute at least one agent, wherein the remedy server comprises an agent module configured to provide at least one agent to a plurality of the computer nodes with the common vulnerability, and wherein the at least one agent comprises an agent configured to receive the multicast fix and execute the multicast fix on the computer node.

18. A computer-readable medium comprising computer-executable instructions for execution by at least one processor, that, when executed, cause the at least one processor to:
receive a plurality of scan results that indicate one or more vulnerabilities on a plurality of computers of a computer network;
generate a vulnerability table that associates a vulnerability with one or more of the plurality of computers that exhibit the vulnerability; and
store the vulnerability table in a memory.

19. The computer readable medium according to claim 18 comprising instructions that, when executed by the at least one processor, cause the at least one processor to:
select a vulnerability of the vulnerability table;
look up the selected vulnerability in a database that associates the selected vulnerability with a location of a fix for the selected vulnerability;
retrieve the fix from the location;
select the computers associated with the vulnerability in the vulnerability table; and
multicast the fix to the selected computers.

20. The computer readable medium according to claim 19 comprising instructions that, when executed by the at least one processor, cause the at least one processor to communicate an agent to the selected computers, wherein the agent is configured to receive the multicast and execute the fix.
